(19) United States
(12) Patent Application Publication
(10) Pub. No.: US 2024/0027761 A1
(43) Pub. Date: Jan. 25, 2024

(54) SYSTEMS AND METHODS FOR STRAY LIGHT ARTIFACT MITIGATION

(71) Applicant: SOLUTIA INC., ST. LOUIS, MO (US)

(72) Inventors: FRANCOIS ANDRE KORAN, LONGMEADOW, MA (US); CASEY LYNN ELKINS, KINGSPORT, TN (US); STEVEN V. HALDEMAN, HAMPDEN, MA (US); JAIME ANTONIO LI, MARTINSVILLE, VA (US)

(73) Assignee: SOLUTIA INC., ST. LOUIS, MO (US)

(21) Appl. No.: 18/255,653

(22) PCT Filed: Dec. 2, 2021
(86) PCT No.: PCT/US2021/061518

§ 371 Date: Jun. 2, 2023

Related U.S. Application Data
(60) Provisional application No. 63/121,318, filed on Dec. 4, 2020.

(51) Int. Cl. G02B 27/01

(52) U.S. Cl. CPC G02B 27/0103; G02B 2027/0194

(57) ABSTRACT

Display systems for viewing information are disclosed, that comprise a glazing, one or more holographic optical elements which reflect light within three or more discrete wavelength ranges; and one or more narrow-band absorbers that selectively absorb light of the same wavelengths as those reflected by the holographic optical elements. Also disclosed are methods of preventing or reducing stray light artifacts resulting from reflection or transmission from one or more holographic optical elements.

### FIELD OF THE INVENTION

The present invention is generally directed to mitigating stray light artifacts in head-up-display systems.

### BACKGROUND OF THE INVENTION

In its most common form, a head-up-display (HUD) automotive system may comprise a computerized signal generator, a projector, and a laminated glass windscreen system that acts as a reflection screen for the projected image. The images generated by the signal generator are fed to the projector, which generates light patterns, expands and collimates the light images through a series of mirrors, and projects the images towards the windscreen at a specially selected angle designed to maximize reflection intensity to a driver.

As the projected image hits the inner surface of the windshield, that is, the air-glass interface, it encounters a significant change in refractive index that causes part of the image intensity (light) to be reflected off the surface, in the direction of the driver eyebox. This image, termed the primary image, travels to the driver's pupils in the form of visual information. The part of the image that is not reflected at the inner glass surface continues through the PVB and glass, with only small changes to refraction angle resulting from minor variations in refractive indices between the glass and polymer interlayer(s). Once the transmitted light reaches the outer glass surface, it encounters a large refractive index change at the air interface and a portion of the light is reflected back in. This reflected image travels back through the laminate and a significant portion emerges from the laminate traveling to a point outside of the driver's vision (thus unseen).

There exists, however, a second series of light rays emerging at a slightly different angle from the projector that travels a similar path into and back out of the laminate that is reflected at an angle such that the reflection off the outer glass surface is perceived by the driver. This is often referred to as the secondary image. When the front and rear glass lites in a laminate are essentially parallel to each other, the perceived primary and secondary images are slightly offset, with the secondary image appearing to be a lower intensity ‘ghost’ image of the primary image.

In most commercial applications, OEMs make use of wedged PVB interlayers that create a non-parallel angle between the inner and outer glass lite, in order to bring the secondary image into alignment with the first. This technique is quite effective, but has inherent drawbacks around cost, lamination complexity, and size limitations of the driver eyebox that can be projected to with current vehicle constraints. The automotive industry has thus been actively working on developing ways to create crisp, ghost-free HUD images without wedged interlayers.

Those familiar with holographic technology have proposed using a layer comprising holographic optical elements (HOE's) embedded in a windscreen to reflect light from a dash-mounted projector. Such angularly-selective reflective elements reflect light only coming in from a very tight set of angles, while allowing passage of light from most other angles. The result of such a scheme would be a windshield system that would reflect incoming light from an in-dash projector system, while providing light from most other angles unhindered passage through the HOE. This would enable a driver to simultaneously see what is occurring outside the vehicle, as well as perceive informational imagery projected from the projector.

Early innovators in this field have successfully designed and produced prototype HOE films capable of demonstrating the ability to reflect the angularly targeted projected light while maintaining the ability to transmit through at other angles. They have all, however, faced significant challenges maintaining desired optical properties when incorporating their films into finished windscreens. One of the key issues hindering the commercialization of windshield integrated HOE-based HUD solutions is the issue of unwanted secondary straylight artifacts. These artifacts can be viewed: 1) externally as illuminated reflections, often colored, from certain angles outside of the vehicle, and (2) internally as modifications to externally transmitted light perceived inside the cabin of the vehicle. Such artifacts are unwanted because they can create unwanted aesthetics and can distract the driver during vehicle operation.

To understand the source of the light artifacts, one must first understand that the holographically-produced phase gratings of the HOEs used for projected light reflection are produced from optically clear materials (albeit with differing refractive indices). These gratings can be produced with global or local light modification properties, often acting as simple mirrors, but sometimes more akin to more complex lenses. They are designed to redirect a tailored spectrum of light, within a narrow width of incoming angles, to a secondary set of narrow light angles in the driver eyebox, all occurring within the vehicle itself (projector to windscreen to driver). Light outside of the tailored spectrum, and outside of the reflective angles, is expected to pass through the gratings, with very little apparent modification, to the driver.

The interesting, and unfortunate, consequence of using optically transparent materials is that the optically clear HOE reflection gratings are also capable of modifying light from external angles complementary to the axis of symmetry of the desired internal reflection angles. As such, while low angle projector light can be modified to reflect to the driver, high angle external light can be similarly modified to reflect down externally. This property, fundamental to the HOE, results in light reflections from higher angle light sources such as the sun, streetlights, or oncoming headlights. These reflections generally occur at a narrow set of external incoming light angle paths, and are typically most visible from a narrow set of external viewing angles, which are once again complementary to the internal HOE design angles.

A second consequence of externally reflected light can be perceived in the interior of the vehicle. As external light typically comprises a broad spectrum, and as HOEs are typically designed to manipulate only the narrow light spectrums emitted by the projector, it is the case that external light not externally reflected by the HOE gratings travels through to the inside of the vehicle. Without the reflected light components, this transmitted light appears different in nature to incoming light coming in around the patterned HOE reflection area. To make matters worse, in some cases HOE pattern imperfections cause a physical separation of different wavelengths, similar to a prism effect, causing internally transmitted light to have a positional effect with color, or a rainbow effect.

The interactions between the primary reflections HOEs and external light thus result in a number of undesirable artifacts. External reflections cause the patterned HOE sections to light up dramatically at certain incoming/outgoing angle pairs, creating unwanted aesthetic issues. Internally transmitted light, falling outside of the HOE-modified spectrum, travels into the vehicle with a different intensity and appearance to that of the incoming light travelling in non-HOE-patterned areas. This both distracts the driver and creates unwanted aesthetics. There is thus a clear unmet need for holographic laminate constructions that have been specially designed with elements that both enable primary projector reflections while mitigating perceived secondary internal and external stray light reflections and transmissions and other optical artifacts.

U.S. Pat. No. 7,777,960 discloses a projection system, such as a system suitable for head-up displays in automobiles, that includes a laser projection source and a scanner. Light from the laser projection source is scanned across a projection surface, which can be a car's windshield. The projection surface includes a buried numerical aperture expander capable of reflecting some light and transmitting other light. The system may also include an image projection source capable of presenting high-resolution images on a sub-region of the projection surface that has an optical relay disposed therein.

EP2045647A1 discloses a head-up display having a projection unit with an imager for generating a virtual image, wherein the light source of the imager emits light in three colored bands. The projected image is viewed on a combiner. According to the invention, the combiner has a triple notch filter on its concave side facing the observer and an anti-reflection coating on its convex side facing away from the observer.

U.S. Pat. Appln. PubIn. No. 2018/0031749 discloses a metamaterial optical filter including: a transparent substrate; and a photosensitive polymer layer provided to the transparent substrate, wherein the photosensitive polymer layer is treated using a laser to form a non-conformal holographically patterned subwavelength grating, the holographic grating configured to block a predetermined wavelength of electromagnetic radiation.

U.S. Pat. Appln. PubIn. No. 2018/0186125 discloses a laminate that utilizes the ability of a narrow band absorbing dyes to absorb selective wavelengths of light by identifying a color target and tuning to that target. Working with just glass compositions, coatings, interlayers and films, all of which act as broad band filters, it is said to be difficult to fine tune the spectral response of a laminate. Narrow band absorbing dyes are used to selectively tune the spectral response to achieve targeted performance in the UV, visible and IR ranges of the spectrum.

A continuing need exists for improved head-up-displays with strong primary images that avoid secondary images and ghosting that detract from viewer experience.

### SUMMARY OF THE INVENTION

In one aspect, the invention relates to methods of preventing or reducing stray light artifacts resulting from reflection or transmission from one or more holographic optical elements, comprising placing one or more narrow-band absorbers between a light source and the one or more holographic elements that absorb the light that causes stray light artifacts.

In another aspect, the invention relates to methods of preventing or reducing stray light artifacts resulting from reflection or transmission from one or more holographic optical elements, comprising placing one or more narrow-band absorbers that absorb the stray light artifacts between the one or more holographic optical elements and a potential viewer.

In yet another aspect, the present invention relates to display systems for viewing information, that comprise a glazing that includes a first transparent rigid substrate; a second transparent rigid substrate; and a polymer interlayer, positioned between the first transparent substrate and the second transparent substrate, one face of the first transparent rigid substrate defining an inner surface of the glazing and one face of the second transparent rigid substrate defining an outer surface of the glazing. The display systems of the invention further comprise one or more arrangements of holographic optical elements which reflect light within three or more discrete wavelength ranges; and one or more narrow-band absorbers that selectively absorb light within the three wavelength ranges, disposed between the holographic-optical elements and the outer surface of the glazing.

Further aspects of the invention are as disclosed and claimed herein.

### BRIEF DESCRIPTION OF THE DRAWINGS

FIG. 1 depicts a display system according to one method of incorporating HOE films into a windshield.

FIG. 2 depicts a display system according to an embodiment of the invention.

FIG. 3 depicts a display system according to yet another method of incorporating HOE films into a windshield.

FIG. 4 depicts a display system according to a further embodiment of the invention.

### DETAILED DESCRIPTION

In one aspect, the present invention is thus directed to display systems for viewing information, that comprise a glazing that includes a first transparent rigid substrate; a second transparent rigid substrate; and a polymer interlayer, positioned between the first transparent substrate and the second transparent substrate, one face of the first transparent rigid substrate defining an inner surface of the glazing and one face of the second transparent rigid substrate defining an outer surface of the glazing. The display systems of the invention are further provided with one or more holographic optical elements, which reflect light within three or more discrete wavelength ranges; and one or more narrow-band absorbers that selectively absorb light of the same wavelengths as those reflected by the holographic optical elements, disposed between the holographic-optical elements and the outer surface of the glazing.

In another aspect, the invention relates to methods of preventing or reducing stray light artifacts resulting from reflection or transmission from one or more holographic optical elements, comprising placing one or more narrow-band absorbers, between a light source and the one or more holographic elements, that absorb the light that causes stray light artifacts. In other aspects, the method relates to the use of two or more narrow-band absorbers, or three or more narrow band absorbers, or as further described herein.

In yet another aspect, the invention relates to methods of preventing or reducing stray light artifacts resulting from reflection or transmission from one or more holographic optical elements, comprising placing one or more narrow-band absorbers, that absorb the stray light artifacts, between the one or more holographic optical elements and a potential viewer. In other aspects, the method relates to the use of two or more narrow-band absorbers, or three or more narrow band absorbers, or as further described herein.

Thus, in one embodiment, the invention relates to display systems for viewing information, that include a glazing, comprising: a first transparent rigid substrate; a second transparent rigid substrate; and a polymer interlayer, positioned between the first transparent substrate and the second transparent substrate. In this embodiment, one face of the first transparent rigid substrate defines an inner surface of the glazing and one face of the second transparent rigid substrate defines an outer surface of the glazing. The display systems further comprise one or more holographic optical elements which reflect light within three discrete wavelength ranges; and one or more narrow-band absorbers that selectively absorb light within the three discrete wavelength ranges, disposed between the holographic-optical elements and the outer surface of the glazing.

In a second display system embodiment, according the first embodiment. the holographic optical elements are positioned in the polymer interlayer.

In a third display system embodiment, according to any of the preceding embodiments, the holographic optical elements are positioned on the inner surface of the glazing.

In a fourth display system embodiment, according to any of the preceding embodiments, the holographic optical elements are provided in or on a film positioned between the first rigid substrate and the polymer interlayer.

In a fifth display system embodiment, according to any of the preceding embodiments, the display systems further comprise a projector that emits light toward the first transparent rigid substrate of the glazing at the three discrete wavelength ranges.

In a sixth display system embodiment, according to any of the preceding embodiments, the one or more holographic optical elements are positioned in the projector.

In a seventh display system embodiment, according to any of the preceding embodiments, the one or more holographic optical elements are positioned between a light source in the projector and the inner surface of the glazing.

In an eighth display system embodiment, according to any of the preceding embodiments, the one or more holographic optical elements are static.

In a ninth display system embodiment, according to any of the preceding embodiments, the one or more holographic optical elements are created dynamically.

In a tenth display system embodiment, according to any of the preceding embodiments, the projector is selected from a laser diode-based projector; an LED projector; a DPSS laser-based projector, a hybrid laser-LED projector, a laser projector, a light source combined with a spatial light modulator, or a light source combined with a waveguide.

In an eleventh display system embodiment, according to any of the preceding embodiments, the three discrete wavelength ranges include light of 445 nm, 515 nm, and 642 nm.

In a twelfth display system embodiment, according to any of the preceding embodiments, the three discrete wavelength ranges include light of 445 nm, 550 nm, and 642 nm, and have a width from about 0.5 nm to about 50 nm.

In a thirteenth display system embodiment, according to any of the preceding embodiments, one of the discrete wavelength ranges emitted by the projector includes light having a wavelength selected from one or more of 635, 638, 650, or 660, and has a width from about 0.5 nm to about 50 nm.

In a fourteenth display system embodiment, according to any of the preceding embodiments, at least one of the narrow-band absorbers is a polymethine dye.

In a fifteenth display system embodiment, according to any of the preceding embodiments, the holographic optical elements comprise one or more diffraction gratings.

In a first method embodiment, the invention relates to methods of preventing or reducing stray light artifacts resulting from reflection or transmission from one or more holographic optical elements, the methods comprising placing one or more narrow-band absorbers between a light source and the one or more holographic elements that absorb the light that causes the stray light artifacts.

In a second method embodiment, according to the first method embodiment, the intensity of at least one stray light artifact is reduced by at least 50%.

In a third method embodiment, according to any of the preceding method embodiments, the narrow band absorbers and the one or more holographic optical elements are provided in a display system for viewing information. In this embodiment, the display system comprises: a glazing, comprising: a first transparent rigid substrate; a second transparent rigid substrate; and a polymer interlayer, positioned between the first transparent substrate and the second transparent substrate, wherein one face of the first transparent rigid substrate defines an inner surface of the glazing and one face of the second transparent rigid substrate defines an outer surface of the glazing. In this embodiment, the display system further comprises the one or more holographic optical elements which reflect light within three discrete wavelength ranges; and the one or more narrow-band absorbers that selectively absorb light within the three discrete wavelength ranges, the one or more narrow-band absorbers being disposed between the holographic-optical elements and the outer surface of the glazing.

In a fourth method embodiment, according to any of the preceding method embodiments, the holographic optical elements are positioned in the polymer interlayer.

In a fifth method embodiment, according to any of the preceding method embodiments, the holographic optical elements are positioned on the inner surface of the glazing.

In a sixth method embodiment, according to any of the preceding method embodiments, the holographic optical elements are provided in or on a film positioned between the first rigid substrate and the polymer interlayer.

In a seventh method embodiment, according to any of the preceding method embodiments, the display system further comprises a projector that emits light toward the first transparent rigid substrate of the glazing at the three discrete wavelength ranges.

In an eighth method embodiment, according to any of the preceding method embodiments, the one or more holographic optical elements are positioned in the projector.

In a ninth method embodiment, according to any of the preceding method embodiments, the one or more holographic optical elements are positioned between a light source in the projector and the inner surface of the glazing.

In a tenth method embodiment, according to any of the preceding method embodiments, the one or more holographic optical elements are static.

In an eleventh method embodiment, according to any of the preceding method embodiments, the one or more holographic optical elements are created dynamically.

In a twelfth method embodiment, according to any of the preceding method embodiments, the projector is selected from a laser diode-based projector; an LED projector; a DPSS laser-based projector, a hybrid laser-LED projector, a laser projector, a spatial light modulator, or a waveguide projector.

In a thirteenth method embodiment, according to any of the preceding method embodiments, the three discrete wavelength ranges include light of 445 nm, 515 nm, and 642 nm, and have a width from about to about 50 nm.

In a fourteenth method embodiment, according to any of the preceding method embodiments, the three discrete wavelength ranges include light of 445 nm, 550 nm, and 642 nm, and have a width from about to about 50 nm.

In a fifteenth method embodiment, according to any of the preceding method embodiments, one of the discrete wavelength ranges emitted by the projector includes light having a wavelength selected from one or more of 635, 638, 650, or 660, and has a width from about 0.5 nm to about 50 nm.

In a sixteenth method embodiment, according to any of the preceding method embodiments, at least one of the narrow-band absorbers is a polymethine dye.

In a seventeenth method embodiment, according to any of the preceding method embodiments, the holographic optical elements comprise one or more diffraction gratings.

When we say “the same wavelengths,” or “the same wavelength ranges” or “within the three wavelength ranges” we do not imply mathematical precision. That is, the term “same wavelengths” would include “the same or similar wavelengths.” Naturally, it is desired that the narrow-band absorber absorb precisely the same wavelengths as reflected by the HOEs, but in practice, slightly mismatched absorptions are satisfactory, so long as the wavelengths of interest are eliminated or reduced satisfactorily.

Similarly, when we say that selectively reflected, projected, or absorbed light is within a wavelength range, it can be anywhere within the wavelength range. Those skilled in the art will understand that as much overlap as possible is desired, but in practice, the wavelength ranges described may overlap more loosely than might otherwise be desired.

In one aspect as used herein, a “display system,” or a “head-up-display system,” comprises a glazing, that includes a first transparent rigid substrate; a second transparent rigid substrate; and a polymer interlayer, positioned between the first transparent substrate and the second transparent substrate. One face of the first transparent rigid substrate defines an inner surface of the glazing, and one face of the second transparent rigid substrate defines an outer surface of the glazing. The display systems further comprise one or more holographic optical elements which reflect light within three or more discrete wavelength ranges; and one or more narrow-band absorbers that selectively absorb light of the same or similar wavelengths as those reflected by the holographic optical elements, disposed between the holographic-optical elements and the outer surface of the glazing.

In another aspect, the display systems may further comprise a projector that emits light toward the first transparent rigid substrate of the glazing at the three or more discrete wavelength ranges.

In another aspect, the invention relates to methods of reducing or preventing stray light artifacts resulting from reflection or transmission from one or more holographic optical elements, comprising placing one or more narrow-band absorbers between a light source and the one or more holographic elements.

When we say “stray light artifacts” we mean to include any light transmitted or reflected by the holographic optical elements in an undesired fashion. For example, the stray light artifacts to be eliminated or masked may be caused by light from inside or outside a vehicle reflecting from the HOEs in a head up display in an undesired fashion. The narrow-band absorbers of the invention provided between the holographic-optical elements and the outer surface of the glazing, absorb light entering the vehicle that causes these external reflections and/or unintended internal transmitted intensity and or color differences, thus eliminating the source of the mentioned aesthetic challenges. If the holographic elements are intended, for example, to reflect at three discrete wavelength ranges, as further described herein, then the narrow band absorbers of the invention will be selected to match or closely match the stray light artifacts at these three discrete wavelength ranges.

In yet another aspect, the invention relates to methods of preventing or reducing stray light artifacts resulting from reflection or transmission from one or more holographic optical elements, comprising placing one or more narrow-band absorbers between the one or more holographic optical elements and a potential viewer. In this aspect, the narrow-band absorbers are placed after the light reaches the holographic optical elements and the stray light artifacts have already been formed. When we say “potential viewer,” we mean the one who would observe the stray light artifacts if the narrow band absorbers did not block them, regardless of whether the narrow band absorbers are placed to block incoming light from reaching the holographic optical elements, or to block the stray light artifacts once created by the holographic optical elements. In one embodiment, then, the potential viewer would be outside the vehicle, and would see stray light artifacts from sunlight reflecting off of the HOEs, were the narrow band absorbers absent.

In both these aspects of preventing or reducing stray light artifacts resulting from reflection or transmission from one or more holographic optical elements, the number of discrete wavelength ranges that need to be blocked by the narrow band absorbers will, of course, depend on the number of discrete wavelength ranges of stray light artifacts that need to be blocked, as these terms are further described herein.

In one aspect, the invention includes a “glazing” or laminated glass windscreen system that acts as a reflection screen for a projected image, thus from the viewer's perspective displaying information on the glazing. Images generated, for example, by a computerized signal generator are fed to the projector, which generates light patterns, typically expanding and collimating the light images through a series of mirrors and projecting the images toward the windscreen at a specially selected angle designed to maximize reflection intensity to the driver.

As used herein, the “glazing” thus typically includes a first transparent rigid substrate, a second transparent rigid substrate, and a polymer interlayer positioned between the first substrate and the second substrate. The rigid transparent substrates are typically glass, although polymers such as polycarbonate may alternatively be used. The polymer interlayer may be a single layer of a polymer, such as PVB, or may be a compound interlayer comprising multiple layers of polymers or other elements necessary for the intended effect, as further described herein.

In the aspect in which a compound interlayer is present in the glazing and the rigid substrates are glass, we can consider the glazing to have four surfaces or interfaces. The first interface, or inner surface of the glazing, is the interface between the air inside the vehicle and the first surface of the first glass lite. This is the interface at which the primary image is reflected to the viewer. The second interface is at the second surface of the first glass lite and the interlayer. The third interface is that between the interlayer and the first surface of the second glass lite, and the fourth interface, or outer surface of the glazing, is that between the exterior (second) surface of the second glass lite and the air. It is understood that in this description, in some circumstances the compound interlayer is comprised of multiple components and may include an HOE film. According to the present invention, the stray light artifacts to be eliminated or masked are caused by light from inside or outside the vehicle reflecting from the HOEs in an undesired fashion. The narrow-band absorbers of the invention provided between the holographic-optical elements and the outer surface of the glazing, absorb the light that causes these external reflections and/or unintended internal transmitted color differences, thus reducing or eliminating the source of the mentioned aesthetic challenges.

As used herein, “primary image” thus refers to the part of a projected image that is reflected off a display surface in the direction of the driver, sometimes referred to as the “driver eyebox”. This primary image is an intended image which is reflected and travels to the driver's pupils in the form of visual information. According to the invention, the reflection can be a result of the light or image encountering a significant change in refractive index at an interface that causes part of the image intensity (light) to be reflected. A further method of obtaining a desired reflection according to the invention is by the use of one more holographic optical elements, in or on the glazing, that reflect light, as further described herein.

As used herein, “secondary image” is distinct from the “primary image” and is an unwanted image. Instead of reflecting from an intended display surface toward a viewer, the secondary image arises from unwanted reflections such as those created by the refractive index difference between the outside of the second transparent rigid substrate of the glazing and the exterior air. Other unwanted reflections, images, or stray light artifacts include those created by sunlight, or other light sources, interacting with holographic optical elements in a glazing, from outside a vehicle.

A “hologram” as used herein refers generally to a physical recording of an interference pattern that uses diffraction to reproduce a three-dimensional light field, resulting in an image which may retain the depth, parallax, and other related properties of the original scene. In one aspect, a hologram is thus a recording of a light field rather than a recording of an image formed by a lens. The holographic medium may be unintelligible or indeed create unwanted light reflections and images when viewed under “normal” light, since it is an encoding of the light field as an interference pattern of variations in opacity, density, and surface profile of the medium. It is only when suitably lit that the interference pattern diffracts the light into an accurate reproduction of the original light field. This light is ideally provided by lasers, although in some uses this is impractical. In some reflection holograms, for example, white light may be used as an illumination source.

“Holographic optical elements” (or HOEs) as used herein refer to optical elements such as lenses, filters, beam splitters, or diffraction gratings, that may be produced using holographic imaging processes or principles, that modify light at at least one wavelength range, or at least two wavelength ranges, or at least three wavelength ranges. In one aspect, the holographic optical elements function as angularly-selective reflective elements, or ASREs, reflecting desired wavelength range(s) in a desired direction while allowing other wavelengths and/or directions to pass through. These HOEs form the light of desired wavelengths such that the image seen by the viewer depends upon the angle from which it is viewed.

In most cases, HOEs will be patterned using a photopolymer film comprised of a substrate and photo-curing polymers of different refractive indices. HOE patterns can be imparted on the photopolymer however desired across the surface of the substrate. In some cases, the HOE patterning may cover the entire film or windshield, while in other cases, the HOE patterning may be limited to a smaller, HUD-reflecting area of substrate. Thus, when we say “HOE-patterned area,” we are referring to an area of the substrate that is the HOE, in that it modifies light as just described. In some embodiments the substrate may be glass. In other embodiments the substrate is a polymer films, for example PET, PA, or TAC. Regardless of the substrate, the final HUD product may incorporate the substrate, or it may be removed prior to incorporation into the HUD product.

According to one aspect of the invention, the display systems are thus provided with one or more of these holographic optical elements, which reflect light within three or more discrete wavelength ranges; and one or more narrow-band absorbers that selectively absorb light of the same wavelengths as those reflected by the holographic optical elements, disposed between the holographic-optical elements and the outer surface of the glazing.

In one aspect, these holographic optical elements may be positioned in the polymer interlayer, for example dispersed in a PVB that comprises the polymer interlayer. In another aspect, the holographic optical elements may be positioned on the inner surface of the glazing. In yet another aspect, the holographic optical elements may be provided in or on a film, such as a PET film, positioned between the first rigid substrate and the polymer interlayer, or positioned in the projector, for example between a light source and the inner surface of the glazing.

In various aspects of the invention, these HOEs may thus be in or on the glazing, in which case they may both form and reflect the light emitted by the projector. In a most basic case, the HOEs take the incoming light and redirect it, through reflection, towards the driver eyebox. In a more complex case, the reflected light is also collimated by the HOE to modify the virtual image distance perceived by the driver. In such cases, the HOE may either further collimate, to extend the virtual image distance, or reduce collimation, to shorten virtual image distance and broaden the eyebox viewing window.

In another case, these HOEs may be in the projector which projects the information to a combiner. In such cases, the light modification by the HOEs can occur through light reflection off the HOE, as described in glazing-mounted HOEs, or through light transmission through the HOE film. In either case, the light may also be additionally modified to adjust the driver perceived virtual image distance, as desired.

When we say “combiner,” we mean any transparent or semi-transparent device in the driver's or passenger's field of view designed to reflect the HUD image while also allowing a view of the exterior environment. The windscreen may act as a “combiner” in this manner, or other devices may be installed into the vehicle to act as a “combiner”.

It is understood, as known to those skilled in the art, that a single HOE film may be employed to modify light of more than one wavelength range, in a forming process referred to as multiplexing. It is also understood that multiple HOEs, each modifying light of a single wavelength range, or multiple wavelength ranges, may be combined to provide a similar effect.

The narrow-band absorbers of the invention selectively absorb light of the same wavelengths as those reflected by the holographic optical elements. These wavelengths may be the same as those emitted by an optional projector or emitter when used to project an image. Typical HUD projectors emit light at three narrow wavelengths representing the three primary colors of red, green, and blue, using the RGB additive color model. These typically correspond, for example, to approximately 580-700 nm (red), 480 nm to 580 (green), and 400-480 nm (blue). In a more specific embodiment, the wavelength ranges in the RGB model may be considered to be 600-700 nm (red), 500-560 nm (green), and 400-490 nm (blue). Alternatively, we may consider these ranges to be 625-680 nm (red), 510-550 nm (green), and 420-460 nm (blue), or as described elsewhere herein. The three-color combination enables the production of a nearly infinite set of projected colors in the final image. The narrow breadth of each color or wavelength range is designed to minimize effects to the bulk of the light passing through the windshield. The light-absorbing substrate according to the invention may be provided with similarly-matched narrow wavelength absorbers in order to maintain the desired HUD windshield properties.

As used herein, the terms “projector,” “emitter,” and “light emitter” are used to describe elements that emit or project light, and especially multiple selected wavelength ranges.

The role of the projector in an automotive HUD display application is typically to generate an image for viewing on a semi-transparent combiner. According to one aspect of the invention, an HOE film is used to modify the image for improved viewing by an observer. As mentioned earlier, in some cases, the HOE film reflects light of selected wavelength to the viewer at a desired angle. In other cases, it transmits light from one point of entry to a different point of exit. In yet other cases it modifies the degree to which the light is collimated to create a perceived virtual image distance for the imagery. In other cases, it diffracts light to expand the range of positions viewable by an observer. And in other cases, it modifies the light path to ensure a properly viewed image that is corrected for the physical dimensions of the windshield

Those skilled in the art will recognize that HOE's are not limited to accomplish only these functions. They will also recognize that HOEs can be designed so as to accomplish one, two, three, or more of these functions, either in one location, or in different areas of the HOE. Those skilled in the art also understand that HOE's can be stacked to combine different effects.

The exact location of the HOE is not critical, so long as it is positioned along the path of light travel between the image generation and the intended reflection boundary in a HUD combiner.

In some aspects of the invention, the HOE film is positioned inside the combiner, reflecting and collimating light. In other aspects of the invention, the HOE film is positioned inside the combiner, reflecting and diffracting light. In other aspects, the HOE film may be positioned on a film on the interior of the windshield. In other aspects, the HOE film may be positioned anywhere between a projector and the windshield.

In yet other aspects of the invention, one or more HOE films are positioned inside the projector, reflecting light prior to its emergence from the projector and subsequent travel to the combiner. In similar but different aspects, one or more HOE films are positioned inside the projector, reflecting light, modifying the degree of collimation, and shaping the image to pre-compensate for the effects of windshield shape, all prior to its emergence from the projector, and subsequent travel to the combiner. In yet other aspects, the HOE films positioned inside the projector modify light in transmission, prior to its emergence from the projector, and subsequent travel to the combiner.

As used herein: 1) the wavelength ranges of light reflected by the HOEs, 2) the wavelength ranges absorbed by the narrow band absorbers, and 3) the wavelength ranges emitted by the projector, may all have defined widths, reported herein as FWHM, or full-width half-maximum values, that is, the wavelength range at which half of the maximum intensity of the light reflected is achieved, as calculated by λ2-λ1, where λ1 and λ2 are the wavelengths nearest the respective peak wavelength where the measured light intensity is half of the peak intensity, and λ2>λ1.

While ideally, the wavelength ranges of light reflected by the HOEs, the wavelength ranges absorbed by the narrow band absorbers, and the wavelength ranges emitted by the projector, would all be the same, in practice these ranges may vary relatively widely. For example, the FWHM of the light from a laser projector or the light reflected from an HOE may be close to or even less than one, the FWHM of the light absorbed by a narrow band absorber may in practice be much broader. We may describe three wavelength ranges and their FWHMs as those wavelengths absorbed by the one or more narrow band absorbers, or those reflected by the HOEs, or those emitted by the projector, depending on context. It is understood that these ranges will at least overlap, in order to obtain the desired effect, regardless of how the wavelength ranges are defined.

Thus according to the invention, the wavelength ranges described herein may, depending on context, have a width (FWHM) of at least 0.5 nm, or at least 1 nm, or at least 2 nm, or at least 5 nm, and up to about 5 nm, or up to about 7 nm, or about 10 nm, or about 15 nm, or about 20 nm, or about 25 nm, or about 30 nm, or about 50 nm.

According to one aspect of the invention, the narrow band absorbers are disposed between the holographic-optical elements and the outer surface of the glazing, and selectively absorb light within the wavelength ranges reflected by the HOEs. The narrow band absorbers may thus be provided in a portion of the interlayer beyond the HOE from the viewer's perspective to comprise a light absorbing substrate or may be in or on the second rigid substrate to comprise a light-absorbing substrate.

The light-absorbing substrate as described may thus be any substrate in which or on which the narrow-band absorbers may be placed. The light-absorbing substrate can be a monolayer, or part of a multilayer, and can incorporate multiple other functionalities such as a PVB interlayer function, as known to those skilled in the art.

For example, in one aspect the light-absorbing substrate is a PVB interlayer. In another aspect, the light absorbing substrate is a polymer substrate incorporating the narrow-band absorbers that is positioned between two PVB interlayers, for example a polyester. In another aspect, the light absorbing substrate is disposed on a PVB interlayer, for example by coating a light-absorbing substrate onto the PVB. In yet another aspect, the light absorbing substrate is disposed on the second rigid substrate, for example by coating a layer of light-absorbing substrate that incorporates the narrow-band absorbers onto the second rigid substrate. So long as the light-absorbing substrate is disposed between the holographic-optical elements and the outer surface of the glazing so as to absorb stray light from the HOEs that would otherwise create stray light artifacts, the stray light artifacts will thus be reduced or eliminated.

In certain embodiments, the polymer interlayer used to form a windshield as described herein may be a single layer, or monolithic, interlayer. In certain embodiments, the interlayer may be a multiple layer interlayer comprising at least a first polymer layer and a second polymer layer. When the interlayer is a multiple layer interlayer, it may also include a third polymer layer such that the second polymer layer is adjacent to and in contact with each of the first and third polymer layers, thereby sandwiching the second polymer layer between the first and third polymer layers. As used herein, the terms “first,” “second,” “third,” and the like are used to describe various elements, but such elements should not be unnecessarily limited by these terms. These terms are only used to distinguish one element from another and do not necessarily imply a specific order or even a specific element. For example, an element may be regarded as a “first” element in the description and a “second” element in the claims without being inconsistent. Consistency is maintained within the description and for each independent claim, but such nomenclature is not necessarily intended to be consistent therebetween. Such three-layer interlayers may be described as having at least one inner “core” layer sandwiched between two outer “skin” layers. In certain embodiments, the interlayer may include more than three, more than four, or more than five polymer layers. As used herein, the terms “core”, “skin”, “first”, “second”, “third”, and the like do not impart any limitations on the thicknesses or relative thicknesses of each layer.

Each polymer layer of the polymer interlayer may include one or more polymeric resins, optionally combined with one or more plasticizers, which have been formed into a sheet by any suitable method. One or more of the polymer layers in an interlayer may further include additional additives, although these are not required. The polymeric resin or resins utilized to form an interlayer as described herein may comprise one or more thermoplastic polymer resins. When the interlayer includes more than one layer, each layer may be formed of the same, or of a different, type of polymer.

Examples of polymers suitable for forming the interlayer can include, but are not limited to, poly(vinyl acetal) polymers, polyurethanes (PU), poly(ethylene-co-vinyl) acetates (EVA), poly(vinyl chlorides) (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and ionomers thereof, derived from any of the previously-listed polymers, and combinations thereof. In some embodiments, the thermoplastic polymer can be selected from the group consisting of poly(vinyl acetal) resins, poly(vinyl chloride), poly(ethylene-co-vinyl) acetates, and polyurethanes, while in other embodiments, the polymer can comprise one or more poly(vinyl acetal) resins. Although generally described herein with respect to poly(vinyl acetal) resins, it should be understood that one or more of the above polymers could be included in addition to, or in the place of, the poly(vinyl acetal) resins described below in accordance with various embodiments of the present invention.

When the polymer used to form interlayer includes a poly(vinyl acetal) resin, the poly(vinyl acetal) resin may include residues of any aldehyde and, in some embodiments, may include residues of at least one C₄ to C₈ aldehyde. Examples of suitable C₄ to C₈ aldehydes can include, for example, n-butyraldehyde, i-butyraldehyde, 2-methylvaleraldehyde, n-hexyl aldehyde, 2-ethylhexyl aldehyde, n-octyl aldehyde, and combinations thereof. In certain embodiments, the poly(vinyl acetal) resin may be a poly(vinyl butyral) (PVB) resin that primarily comprises residues of n-butyraldehyde. Examples of suitable types of poly(vinyl acetal) resins are described in detail in U.S. Pat. No. 9,975,315 B2, the entirety of which is incorporated herein by reference to the extent not inconsistent with the present disclosure.

In certain embodiments, the interlayer may include one or more polymer films in addition to one or more polymer layers present in the interlayer. As used herein, the term “polymer film” refers to a relatively thin and often rigid polymer that imparts some sort of functionality or performance enhancement to the interlayer. The term “polymer film” is different than a “polymer layer” or “polymer sheet” as described herein, in that polymer films do not themselves provide the necessary penetration resistance and glass retention properties to the multiple layer panel, but, rather, provide other performance improvements, such as infrared absorption or reflection character.

In certain embodiments, poly(ethylene terephthalate), or “PET,” may be used to form a polymer film and, ideally, the polymer films used in various embodiments are optically transparent. The polymer films suitable for use in certain embodiments may also be formed of other materials, including various metallic, metal oxide, or other non-metallic materials and may be coated or otherwise surface-treated. The polymer film may have a thickness of at least about 0.012, 0.015, 0.020, 0.025, 0.030, 0.035, 0.040, 0.045, or at least about mm or more.

According to some embodiments, the polymer film may be a re-stretched thermoplastic film having specified properties, while, in other embodiments, the polymer film may include a plurality of nonmetallic layers that function to reflect infrared radiation without creating interference, as described, for example, in U.S. Pat. No. 6,797,396, which is incorporated herein by reference to the extent not inconsistent with the present disclosure. In certain embodiments, the polymer film may be surface treated or coated with a functional performance layer in order to improve one or more properties of the film, including adhesion or infrared radiation rejection. Other examples of polymer films are described in detail in PCT Application Publication No. WO88/01230 and U.S. Pat. Nos. 4,799,745, 4,017,661, and 4,786,783, each of which is incorporated herein by reference to the extent not inconsistent with the present disclosure. Other types of functional polymer films can include, but are not limited to, IR reducing layers, holographic layers, photochromic layers, electrochromic layers, antilacerative layers, heat strips, antennas, solar radiation blocking layers, decorative layers, and combinations thereof.

Additionally, at least one polymer layer in the interlayers described herein may include one or more types of additives that can impart particular properties or features to the polymer layer or interlayer. Such additives can include, but are not limited to, dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB₆) and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers. Additionally, various adhesion control agents (“ACAs”) can also be used in one or more polymer layers in order to control the adhesion of the layer or interlayer to a sheet of glass. Specific types and amounts of such additives may be selected based on the final properties or end use of a particular interlayer and may be employed to the extent that the additive or additives do not adversely affect the final properties of the interlayer or windshield utilizing the interlayer as configured for a particular application.

According to some embodiments, interlayers as described herein may be used to form windshields that exhibit desirable acoustic properties, as indicated by, for example, the reduction in the transmission of sound as it passes through (i.e., the sound transmission loss of) the laminated panel. In certain embodiments, windshields formed with interlayers as described herein may exhibit a sound transmission loss at the coincident frequency, measured according to ASTM E90 at 20° C., of at least about 34, at least about 34.5, at least about 35, at least about 35.5, at least about 36, at least about 36.5, or at least about 37 dB or more.

The overall average thickness of the interlayer can be at least about 10, at least about 15, at least about 20, at least about 25, at least about or at least about 35 mils and/or not more than about 100, not more than about 90, not more than about 75, not more than about 60, not more than about not more than about 45, not more than about 40, not more than about 35, not more than about 32 mils, although other thicknesses may be used as desired, depending on the particular use and properties of the windshield and interlayer. If the interlayer is not laminated between two substrates, its average thickness can be determined by directly measuring the thickness of the interlayer using a caliper, or other equivalent device. If the interlayer is laminated between two substrates, its thickness can be determined by subtracting the combined thickness of the substrates from the total thickness of the multiple layer panel.

Interlayers used to form windshields as described herein can be formed according to any suitable method. Exemplary methods can include, but are not limited to, solution casting, compression molding, injection molding, melt extrusion, melt blowing, and combinations thereof. Multilayer interlayers including two or more polymer layers may also be produced according to any suitable method such as, for example, co-extrusion, blown film, melt blowing, dip coating, solution coating, blade, paddle, air-knife, printing, powder coating, spray coating, lamination, and combinations thereof.

When the interlayer is formed by an extrusion or co-extrusion process, one or more thermoplastic resins, plasticizers, and, optionally, one or more additives as described previously, can be pre-mixed and fed into an extrusion device. The extrusion device can be configured to impart a particular profile shape to the thermoplastic composition in order to create an extruded sheet. The extruded sheet, which is at an elevated temperature and highly viscous throughout, can then be cooled to form a polymeric sheet. Once the sheet has been cooled and set, it may be cut and rolled for subsequent storage, transportation, and/or use as an interlayer.

Co-extrusion is a process by which multiple layers of polymer material are extruded simultaneously. Generally, this type of extrusion utilizes two or more extruders to melt and deliver a steady volume throughput of different thermoplastic melts of similar or different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

Windshields and other types of multiple layer panels may be formed from the interlayers and glazing panels as described herein by any suitable method. The typical glass lamination process comprises the following steps: (1) assembly of the two substrates and the interlayer; (2) heating the assembly via an IR radiant or convective device for a first, short period of time; (3) passing the assembly into a pressure nip roll for the first de-airing; (4) heating the assembly for a short period of time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperature between 135° C. and 150° C. and pressures between 150 psig and 200 psig for about 30 to 90 minutes. Other methods for de-airing the interlayer-glass interface, as described according to one embodiment in steps (2) through (5) above include vacuum bag and vacuum ring processes, and both may also be used to form windshields and other multiple layer panels as described herein.

According to the invention, the display systems are provided with narrow-band absorbers, which may be any molecule, compound, or particle that absorbs light in the desired wavelength range. These would typically be absorbing dyes but could also comprise absorbing pigments. Different narrow band absorbers will likely be employed to absorb at the peak wavelength for each of the projector colors employed. The molecules are ideally incorporated at concentrations that will absorb >50% of the light at each of the peak color wavelengths. In the case of pigments, it is understood that particle size would be minimized to reduce unwanted haze.

By aligning the absorbers with the wavelength ranges modified by the HOE, we can effectively absorb a percentage of the light that causes the external reflections and/or unintended internal transmitted color differences prior to it reaching the HOE, thus minimizing or eliminating the source of the two mentioned aesthetic challenges.

In a preferred aspect, the narrow-band absorbers comprise dyes or pigments that selectively absorb light in discrete wavelength ranges, typically corresponding broadly, for example, to approximately 600-740 nm (red), 500 nm to 565 nm (green), and 420-480 nm (blue).

Thus, when dyes or pigments are used as narrow-band absorbers, the absorption peak, or λmax of the dye or pigment, should be aligned as closely as practicable with the wavelengths modified by the HOE, e.g. 466, 523, 623 nm. HOEs designed to modify different wavelengths can also be employed, provided a balanced RGB output can be achieved to provide a normal color balance. The absorption peak width (FWHM) of the dyes should be as narrow as possible to achieve sufficient absorption of the desired wavelengths, with a minimum impact on visible transmission. FWHM should thus desirably be less than 50 nm, or less than 30 nm. Absorbers should have no, or limited, secondary absorption peaks or shoulders within the range of interest of visible light transmission. When placed in a PVB substrate, the absorbers should be soluble in plasticizer in an amount, for example, from about 30 ppm to about 750 ppm, in order to compound into PVB. The desired concentration will vary based on the molar absorptivity of the absorber, the thickness of the PVB substrate, and the plasticizer level in the PVB substrate, and concentrations outside this range may be possible as well. When the absorbers are dissolved into a solvent for coating, higher concentrations are often typical or desired in order to minimize the coating thickness. For use in PVB, absorbers should have sufficient thermal stability; for example a minimum of 200° C. for compounding or 150° C. for coating and glass lamination. Absorbers should also have sufficient UV stability to survive outdoor exposure in a windscreen for >5 years, when a windscreen is intended. The light-absorbing substrate may also incorporate one or more ultra-violet (UV) blockers; the UV blockers have negligible effect in the visible range. The UV blocker may be a dye that is disposed in or onto the polymer substrate. The UV dye absorber may be coated on the outer surface of the polymer substrate to reduce the exposure of the narrow band absorbers and increase the UV stability of the system. Examples of UV absorber dyes are Maxgard, Cyasorb, and Tinuvin UV stabilizers. In addition to UV blockers, one or more light stabilizers, such as hindered amine light stabilizers (HALS), and/or one or more antioxidants may be incorporated into the light-absorbing substrate to improve the weatherability of the narrow band absorbing dyes.

In one aspect, the narrow-band absorbers comprise pigments. Pigments are differentiated from dyes in that their solubility characteristics in the medium are significantly reduced and are generally considered to be insoluble in the medium. Pigments are comprised of two general classes of molecules, organic and inorganic. Examples of suitable inorganic pigments include compounds or complexes of aluminum, copper, cobalt, manganese, gold, iron, calcium, argon, bismuth, lead, titanium, tin, zinc, mercury, antimony, barium or combinations thereof, including silicates, oxides, phosphates, carbonates, sulfates, sulfides, and hydroxides. (Völz, Hans G.; et al. “Pigments, Inorganic”. Ullmann's Encyclopedia of Industrial Chemistry. Weinheim: Wiley-VCH. doi:10.1002/14356007.a20_243. pub2 \hat{ }Müller, Hugo; Müller, Wolfgang; Wehner, Manfred; Liewald, Heike. ‘Artists’ Colors”. Ullmann's Encyclopedia of Industrial Chemistry. Weinheim: Wiley-VCH. doi:10.1002/14356007.a03_143.pub2.)

Examples of suitable organic pigments include the same chemical classes as described herein for dyes, with differentiated solubility imparted by suitable substituents, most commonly based on aromatic hydrocarbons. When pigments are used as the narrow-band absorbers, they may be present in amounts from about 0.001% to about 50%, or from 0.001% to 25%, or from 0.001% to 10%, or from 0.001 to 1%, or from 0.001% to 0.1%.

The particle size of the pigments may be important, in order to achieve the desired optical quality. Particle size and shape affect both color strength and scattering, which directly impact overall optical quality as well as haze and clarity. Larger particle size and aspect ratio may decrease color strength and increase or decrease scattering, improving haze and, conversely, smaller particle size and aspect ratio increase color strength, and increase or decrease scattering, decreasing haze. Thus, the average particle size of the pigments may be from about 10 nm to about 500 micron, or from 100 nm to 100 micron. In one aspect, the haze caused by the pigments will be less than 5%, 2%, 1.5%, 1%, or 0.5%, as measured by a haze-meter such as the Haze-guard from BYK-Gardner Instruments, according to ASTM D-1003.

In another aspect, the narrow-band absorbers comprise dyes. Dyes suitable for use according to the invention typically possess color because they absorb light in the visible spectrum (about 400 to about 700 nm), have at least one chromophore (color-bearing group), have a conjugated system, that is, a structure with alternating double and single bonds, and exhibit resonance of electrons, a stabilizing force in organic compounds. Most dyes also contain groups known as auxochromes (color helpers), examples of which are carboxylic acid, sulfonic acid, amino, and hydroxyl groups. While these are not responsible for color, their presence can shift the color of a colorant and may be used to influence dye solubility.

According to the invention, the display systems comprise one or more narrow band absorbers, disposed in a vision area of the glazing, that collectively absorb light selectively within three wavelength ranges in the visible spectrum. Thus, a single narrow band absorber may absorb light in more than one wavelength range. The narrow band absorber may have more than one absorption peak, each absorption peak absorbing light in a different wavelength range. Careful selection or design of the narrow band absorber may provide more than one absorption peak, each aligned with a different HOE reflection or projector wavelength range. The narrow band absorber may contain more than one chromophore, the part of the molecule responsible for absorption in the visible range of the electromagnetic spectrum. The narrow band absorber may also comprise more than one dye or pigment that are covalently bonded together to provide one chemical structure having more than one absorption peak, each aligned with a different projector wavelength range.

One class of suitable dyes are polymethine dyes. Polymethine dyes are molecules whose chromophoric system consists of conjugated double bonds (polyenes), where n is uneven, e.g., 1, 3, 5, 7, etc., flanked by two end groups, X and X′. X and X′ are most commonly 0 or N derivatives and are categorized into subclasses.

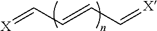

Subclasses can be defined as:
X=X′ Polymethine dyes
X=X′=N Cyanine dyes
X=X′=O Oxonole dyes
X #X′ Meropolymethine dyes
X=N, X′=O Merocyanine dyes

A special case is zwitterionic polymethine dyes, an example shown here:

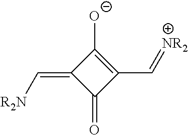

These conjugated systems have the ability to be stabilized through delocalized electronic states and can be tuned with different functional groups as substituents to change the electronic absorption properties of their UV spectrum. As a result, they can exist as neutral molecules or salts (charged species paired with a counter ion). The nitrogen in these molecules can exist in a neutral state or as a positively charged group, for example as an iminium ion paired with an anion. Examples or subclasses of polymethine dyes include cyanine dyes, hemicyanine dyes, streptocyanine dyes, merocyanine dyes, oxonol dyes, porphyrin dyes, tetraazaporphyrin dyes, phthalocyanine dyes, styryl dyes, di- and triarylmethine dyes, squaraine dyes, squarate dyes, and croconate polymethine dyes. Polymethine dyes are generally α,ω-substituted odd polyenes. The dyes can be functionalized in innumerable ways to derive differentiated absorption peaks and widths. Examples of groups used to functionalize dyes include linear aliphatic, cycloaliphatic, aromatic, and heteroaromatic moieties and combinations thereof. Porphyrin dyes, tetraazaporphyrin dyes and phthalocyanine dyes can form complexes with metals to derive differentiated absorption peaks and widths as well. Examples of metals that may form complexes with porphyrin dyes, tetraazaporphyrin dyes and phthalocyanine dyes include transition metals, post-transition metals, alkaline earth metals and alkali metals. In some cases, the metal complexes may contain metal oxides or the metal complexes may contain a halide

Examples of dyes that may selectively absorb light at wavelength ranges from approximately 625-740 nm (red) include N-(4-((4-(Dimethylamino)phenyl)(3-methoxyphenyl)methylene)-cyclohexa-2,5-dien-1-ylidene)-N-methylmethanaminium (Epolin 5262), Epolin 5394, Epolin 5839, Epolin 6661, Exciton ABS626, Exciton ABS642, Cyclobutenediylium, 1,3-bis[(1,3-dihydro-3,3-dimethyl-1-propyl-2H-indol-2ylidene)methyl]-2,4-dihydroxy-, bis (inner salt) (QCR Solutions Corp VIS630A), QCR Solutions Corp VIS637A, QCR Solutions Corp VIS641A, QCR Solutions Corp VIS643A, QCR Solutions Corp VIS644A, QCR Solutions Corp VIS651B, QCR Solutions Corp VIS 654C.

Examples of dyes that may selectively absorb light at wavelength ranges from approximately 500 nm to approximately 565 nm (green) include Epolin 5396, Epolin 5838, 3-pyridinecarbonitrile, 1-butyl-5-[2-(1,3-dihydro-1,3,3-trimethyl-2H-indol-2-ylidene)ethylidene]-1,2,5,6-tetrahydro-4-methyl-2,6-dioxo-(QCR Solutions Corp VIS518A), QCR Solutions Corp VIS523A, QCR Solutions Corp VIS542A.

Examples of dyes that may selectively absorb light at wavelength ranges from approximately 430 to 485 nm (blue) include Propanedinitrile, 2-[[4-[[2-(4-cyclohexylphenoxy)ethyl]ethylamno]-2-methylphenyl]methylene]—(Epolin 5843), Epolin 5852, Epolin 5853, Epolin 5854, Exciton ABS433, Exciton ABS439, Exciton ABS454, QCR Solutions Corp VIS441A.

Examples of dyes suitable for use according to the invention include: Epolin 5262:

CAS Registry Number 42297-44-9

### N-(4-((4-(Dimethylamino)phenyl)(3-methoxyphenyl)methylene)-cyclohexa-2,5-dien-1-ylidene)-N-methylmethanaminium

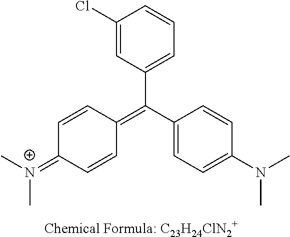

Epolin 5843

CAS Registry number 54079-53-7

### Propanedinitrile, 2-[[4-[[2-(4-cyclohexylphenoxy)ethyl]ethylamno]-2-methylphenyl]methylene]-

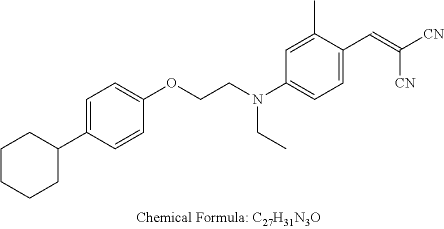 [SMILES: CCN(CCOc1ccc(C2CCCCC2)cc1)c1ccc(C=C(C#N)C#N)c(C)c1]

QCR VIS518A

CAS registry number: 201420-04-4

### 3-pyridinecarbonitrile, 1-butyl-5-[2-(1,3-dihydro-1,3,3-trimethyl-2H-indol-2-ylidene)ethylidene]-1,2,5,6-tetrahydro-4-methyl-2,6-dioxo-

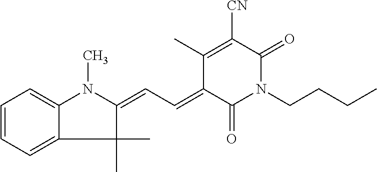 [SMILES: CCCCN1C(=O)C(C#N)=C(C)/C(=C\C=C2\N(C)c3ccccc3C2(C)C)C1=O]

QCR VIS630A

CAS registry number: 201557-75-5

### Cyclobutenediylium, 1,3-bis[(1,3-dihydro-3,3-dimethyl-1-propyl-2H-indol-2ylidene)methyl]-2,4-dihydroxy-, bis (inner salt)

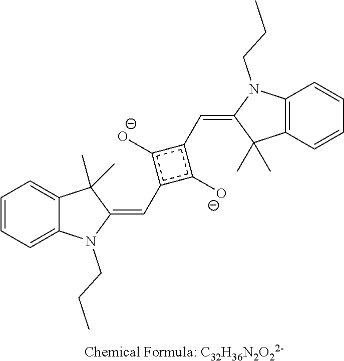

Other dyes suitable for use according to the invention include those disclosed in JP6674174 B2, both methine dyes and metal complex structures, the disclosure of which is incorporated herein by reference. Thus, in this aspect, a metal complex compound represented by the formula (1) may be used:

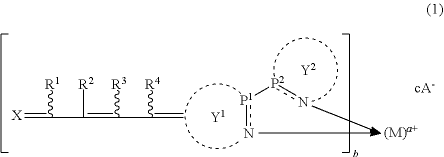

where R1 to R4 are each independently a substituted/unsubstituted alkyl group or the like, X is a monocyclic or polycyclic heterocyclic group or the like, a ring Y1 and a ring Y2 are each independently monocyclic or polycyclic heterocycle, P1 and P2 are each independently C or N, M is Group 3 to Group 12 atom, the arrow is a coordinate bond, a to c are integers of 1 to 3, A is a halide ion or an anion compound such as BF4-.

Metal complex dyes are also suitable for use according to the invention. Metal-complex dyes may be broadly divided into two classes: 1:1 metal complexes and 1:2 metal complexes. The dye molecule will be typically a monoazo structure containing additional groups such as hydroxyl, carboxyl or amino groups, which are capable of forming strong coordination complexes with transition metal ions. Typically, chromium, cobalt, nickel and copper are used.

Azo dyes are also suitable for use according to the invention. The most prevalent metal complex dyes for textile and related applications are metal complex azo dyes. They may be 1:1 dye:metal complexes or 2:1 complexes and contain mainly one (monoazo) or two (disazo) azo groups.

Other dyes suitable for use according to the invention include those disclosed in JP6417633, the disclosure of which is incorporated herein by reference. Thus, azo dyes may be used which are tetraazaporphyrin compounds which are mixtures of 4 kinds of isomers obtained by heat cyclization reaction of a metal or a metal derivative with a cis body of 1,2-dicyanoethylene compound represented by the following formula 1:

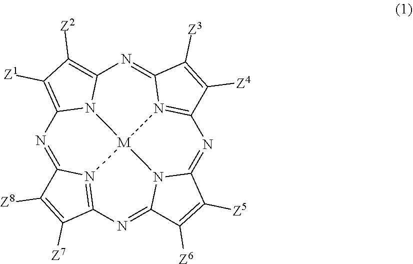

in which one of two substitutions Z1 and Z2 is a cyclic alkyl group which may have a substituent and the other is an aryl group which may have a substituent

Others include those metal complex dyes disclosed in WO201004833, the disclosure of which is incorporated herein by reference.

Others include those disclosed in JP2007211226, which discloses a coloring matter for use in an optical filter which is said to be excellent in durability, capable of cutting a light having unnecessary wavelengths existing in 540-600 nm in order to clear the contrast of an image, and capable of preventing or reducing the mirroring and reflection of a light of 540-560 nm from an external light such as a fluorescent lamp, in order to maintain the distinctness of an indicated image. The compounds disclosed are rhodamine-based compounds expressed by the general formula (1):

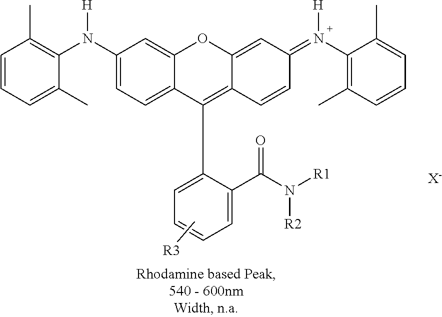

wherein, R1 and R2 are each an aryl group having no substituent or a substituent selected from a methyl group and the like and a halogen and having the number of nuclear carbons of 6-24; R3 is a hydrogen atom, a methyl group or a halogen; and X (sup-) is a counter ion). Xanthene dyes, rhodamine dyes, fluorescein dyes and substituted versions of these dyes are also useful dyes according to the invention.

Other dyes useful according to the invention include carbocyclic azo dyes, heterocyclic azo dyes, indole-based dyes, pyrazolone based eyes, Pyridone based dyes, Azopyrazolone based dyes, S or S/N heterocyclic, metallized azo dyes, Anthraquinone based dyes, Indigoid based dyes, Cationic dyes, Di- and triarylcarbenium dyes, Phthalocyanine dyes, Sulfur Dyes, Metal complexes as dyes, Quinophthalone Dyes, Nitro and Nitroso dyes, Stilbene dyes, Formazan dyes, Triphenodioxazines, Benzodifuranones.

Some dyes useful according to the invention may be proprietary, that is, the actual chemical structure of the dye may not be known. Those skilled in the art of dye preparation and selection can select a suitable dye for use according to the invention based on its particular absorption spectrum, which is typically available from the vendor even when the identity of the molecule itself is not disclosed. Those skilled in the art of compounding, for example PVB interlayers, will understand that a dye, when present in the PVB itself, must survive the processing parameters, which include time at relatively high temperatures, in the presence of plasticizers that might degrade the dye.

When used in PVB interlayers, the narrow-band absorbers should be soluble or dispersible in plasticizer (˜30-750 ppm) to compound into PVB or into some solvent for coating (typically at higher concentration). In this aspect, the absorbers should have sufficient thermal stability, for example a minimum 200° C. for compounding or 150° C. for coating and glass lamination. Further, the absorbers should have sufficient UV stability for the intended use, for example to survive outdoor exposure in a windscreen for >5 years.

Ideally, the dyes useful according to the invention will exhibit absorption peaks (λₘₐₓ) that are aligned with the wavelengths modified by the HOE, for example, of 466 nm, 523 nm, and 623 nm. As noted, HOEs designed to modify different wavelengths may also be employed, so long as a balanced RGB output can be achieved to provide a desired color balance. The absorption peak width (as characterized by the Full Width at Half Maximum or FWHM) of the dyes should also be as narrow as possible to achieve sufficient absorption of the desired wavelengths with a minimum impact on visible transmission. Thus, the FWHM of the dyes may be, for example, less than 10 nm, or less than or less than 30 nm, or less than 40 nm, or less than 50 nm, or less than 60 nm. If the wavelength ranges at which the dyes absorb light are too broad, it will be difficult to achieve the desired reduction in stray light artifacts and/or desired Tᵥᵢₛ values. We note that the FWHM of each of the dyes used may not be the same, and the Tvis value is a weighted average with the human eye response.

Ideally, the narrow-band absorbers will have no or limited secondary absorption peaks or shoulders within the wavelengths of the visible spectrum of light.

How strongly a dye absorbs, known as its absorptivity, does not necessarily impact its performance according to the invention. It is, however, a factor in determining the amount of dye that is required to be incorporated in or on the light absorbing substrate. If the absorptivity of a dye, ε, is known, the Beer-Lambert Law, A=εcl, can be used to calculate the concentration of dye needed, c, to achieve the desired level of absorption, A, from a given light absorbing substrate with thickness t. Dye absorptivities useful according to the invention may range, for example, from 10 to 1000, or from 20 to 800, or from 60 to 700 L/g/cm.

The glazings useful according to the invention may comprise a first transparent rigid substrate and a second transparent rigid substrate. These two rigid substrates are preferably glass, but may be another material such as a polycarbonate, acrylic, polyester, copolyester, and combinations thereof. The two transparent rigid substrates may be of the same material, or two different materials.

The invention thus, in one aspect, describes a completely novel combination of a specially designed selective light absorbing functionality used in combination with holographic reflecting elements in a HUD projection geometry that provides a strong primary HUD image while mitigating perceived secondary external stray light reflections and transmissions.

In one aspect of the invention, an optimal HUD system employs an image generation system, a projector, and a windshield incorporating in a compound interlayer a film containing an HOE capable of redirecting the projector light transmitted past the inner air/glass interface to an angle viewable by the driver. These components comprise a classically hypothesized HOE HUD set-up. The invention, however, further provides a construction incorporating a light-absorbing substrate, located between the primary reflection HOE and the outer glass lite, which is designed to absorb the light that participates in the unwanted effects occurring as a result of external light interactions with the complementary light paths in the primary reflection HOEs.

The invention thus, in one aspect describes the use of a selective light absorbing functionality for the mitigation of secondary stray light artifacts in head up display systems employing windscreen laminated holographic elements. This approach supplements holographically-produced high-efficiency reflecting layer approaches designed to provide a single overwhelmingly visible primary reflection image projected within the field of view of the windshield. While extremely effective, such reflective layers also enable a unique path for external light reflection and transmission that results in unwanted light/color artifacts. The use of a selective light absorbing interlayer incorporated into the laminated windshield is specifically designed to enable HUD solutions with nearly imperceptible stray light artifacts.

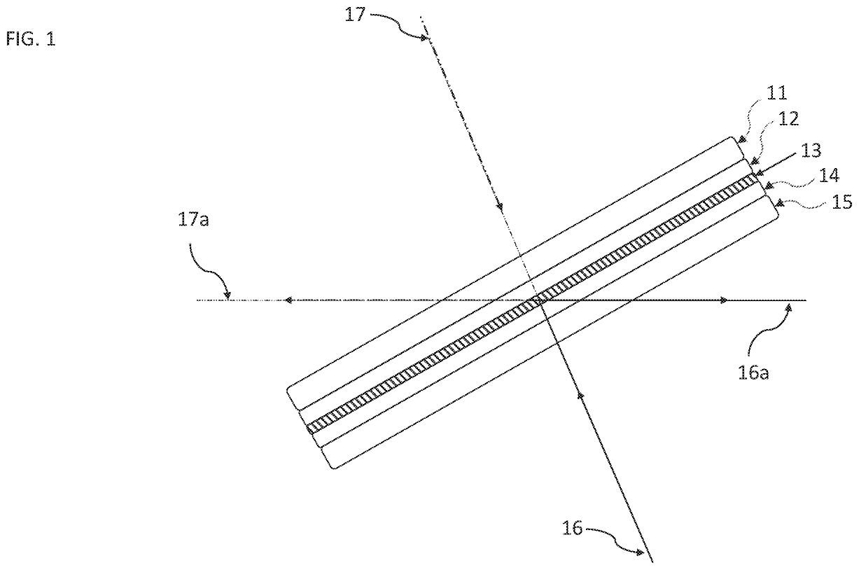

Turning now to the drawings, FIG. 1 depicts a laminated glazing incorporating an HOE film in a simulated HUD geometry. The HOE film, 13, is immediately encapsulated on either side by two polymeric films, 12 and 14. These, in turn, are sandwiched between two rigid substrates, 11 and 15. In this drawing, the rigid substrate 15 indicates the inner glass, that is, the glass on the interior of a vehicle. The rigid substrate 11 is thus the outer glass lite, that is, the glass on the exterior of a vehicle. A light ray, 16, is directed at the inner glass lite 15, and a component of that light is redirected by the HOE back to the interior of the cabin, as shown by light ray 16a. This light path trajectory is that desired in an HOE-enabled automotive head up display system, with light ray 16 representing the light emanating from a dash mounted projector, and light ray 16a representing the light traveling towards the driver's eyebox. Simultaneously, the drawing portrays a situation in which a second light ray 17, directed towards the glazing from outside the vehicle is redirected by the HOE back out away from the vehicle. This redirected light, illustrated by light ray 17a, represents the redirected light, or a stray light artifact, that is visible to viewers external to the vehicle.

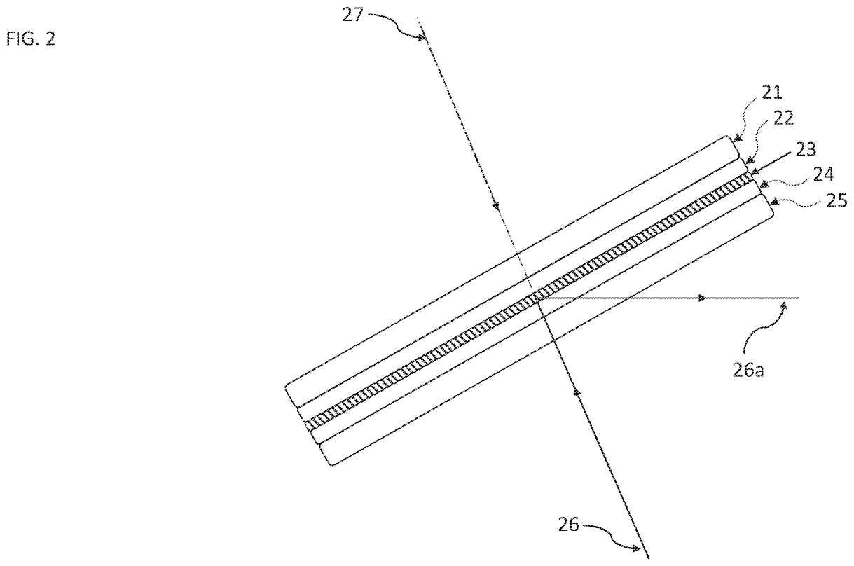

FIG. 2 depicts a laminated glazing incorporating an HOE film in a simulated HUD geometry, depicting one aspect of the invention. The HOE film, 23, is immediately encapsulated on either side by two polymeric films, 22 and 24. These, in turn, are sandwiched between two rigid substrates, 21 and 25. In this drawing, the rigid substrate 25 indicates the inner glass, that is, the glass on the interior of a vehicle. The rigid substrate 21 is thus the outer glass lite, that is, the glass on the exterior of a vehicle. A light ray, 26, is directed at the inner glass lite, and a component of that light is redirected by the HOE back to the interior of the cabin, as shown by light ray 26a. This light path trajectory is that desired in an HOE-enabled automotive head up display system, with light ray 26 representing the light emanating from a dash mounted projector, and light ray 26a representing the light traveling towards the driver's eyebox. Simultaneously, the drawing portrays a situation in which a second light ray 27, directed towards the glazing from the outside of the vehicle is absorbed by the dyes present in the interlayer, 22, and not available for redirection by the HOE back out away from the vehicle. That is, the stray light artifacts that would be caused by the second light ray 27 and redirected back out away from the vehicle are thereby blocked.

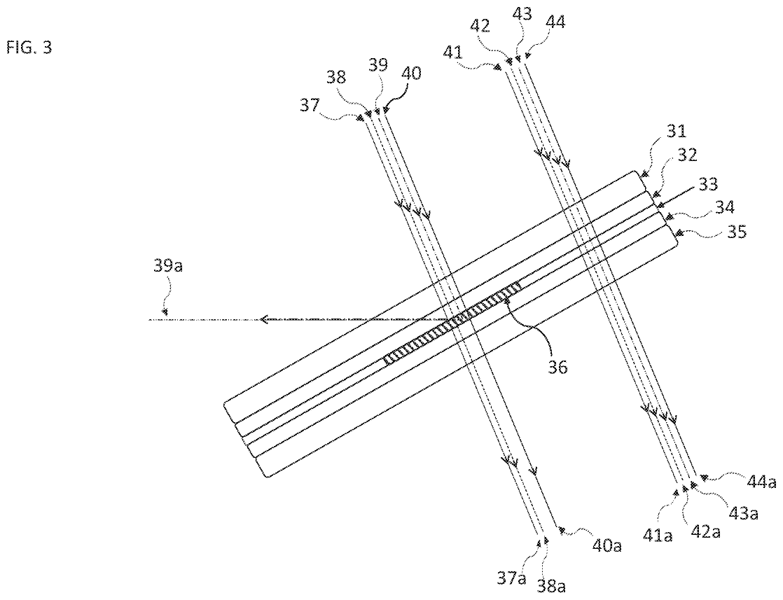

FIG. 3 depicts a laminated glazing incorporating an HOE patch film in a simulated HUD geometry. The HOE film, 36, is immediately encapsulated on all sides by polymeric films, 32, 33 and 34. That is, a spacer film 33 is provided adjacent the HOE patch film. Alternatively, the spacer film 33 may be absent, and films 32 and 34 be allowed to fill that space during the lamination process. Regardless, the polymers are, in turn, sandwiched between two rigid substrates, 31 and 35. In this drawing, the rigid substrate 35 indicates the inner glass, that is, the glass on the interior of a vehicle. The rigid substrate 31 is thus the outer glass lite, that is, the glass on the exterior of a vehicle. Incoming external light is illustrated as a hypothetical group of four different rays of different wavelengths, shown as 37, 38, 39, and 40. This is exemplary, as those skilled in the art understand that light is typically comprised of a range of wavelengths. Thus, in this example, light rays 37-40 and 41-44 may represent the entire spectrum of sunlight, or in other cases, overhead fluorescent light, etc. For the purposes of simplicity, however, this illustration depicts the incoming light as being comprised of only four wavelengths. The rays 37, 38, 39, and 40 pass through the glass, 31, and polymeric interlayer, 32, where they interact with the HOE film, 36. In this example, the HOE film is designed to redirect the wavelength of ray 39 back out to the exterior of the vehicle, as ray 39a. The remaining rays travel through the rest of the construction, emerging as 37a, 38a, 40a. In another location on the glazing, a second set of rays, 41, 42, 43, and 44, with similar properties, enters the laminate in an area without an encapsulated HOE film. This second set of rays travels through the entire laminate without interaction with an HOE film, and emerge virtually unchanged, as rays 41a, 42a, 43a, 44a. An observer looking at the rays transmitted through the vehicle would perceive an intensity and color difference arising from the first set of rays, 37a, 38a, 40a that is missing a component of the incoming set, ray 39a; the second set of rays, 41a, 42a, 43a, and 44a has all elements of the incoming set.

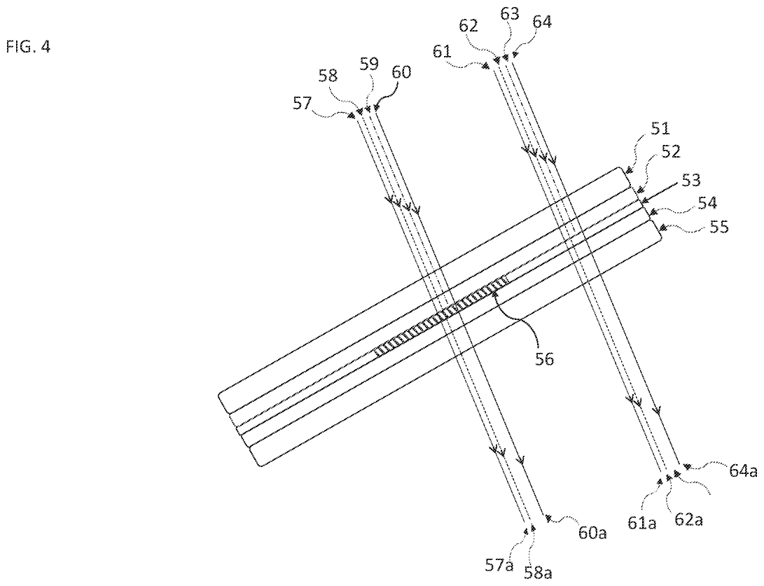

FIG. 4 depicts a laminated glazing incorporating an HOE patch film in a simulated HUD geometry depicting one aspect of the invention. The HOE film, 56, is immediately encapsulated on all sides by polymeric films, 52, 53 and 54. These, in turn, are sandwiched between two rigid substrates, 51 and 55. In this drawing, the rigid substrate 55 indicates the inner glass, that is, the glass on the interior of a vehicle. The rigid substrate 51 is thus the outer glass lite, that is, the glass on the exterior of a vehicle. Incoming external light is illustrated as a hypothetical group of four different rays of different wavelengths, shown as 57, 58, 59, and 60. As noted above, this is exemplary, as those skilled in the art understand that light is typically comprised of a range of wavelengths. For the purposes of simplicity, however, this illustration depicts the incoming light as being comprised of only four wavelengths, and shown as slightly separated for illustration purposes. The rays 37, 38, 39, and 40 pass through the outer glass, 51. The polymeric interlayer 52 is designed to absorb the wavelengths associated with ray 59, which thus becomes absorbed as it passes through the interlayer. The remaining three rays, 57, 58, 60 travel through to the HOE film 56, and pass through essentially unchanged, as it had been designed solely for the redirection of wavelengths similar to ray 59. As such, these remaining rays travel through the rest of the construction, emerging as 57a, 58a, 60a. In another location on the glazing, a second set of rays, 61, 62, 63, and 64, with similar properties, enters the laminate in an area without an encapsulated HOE film. These rays pass through the outer glass 51. The polymeric interlayer 52 is designed to absorb the wavelengths associated with ray 63, which have the same properties as ray 59, which thus becomes absorbed as it passes through the interlayer. The remaining three rays, 61, 62, 64, travel through the rest of the construction, emerging as 61a, 62a, 64a. An observer looking at the rays transmitted through the vehicle would perceive no difference in intensity and color between the first set of emerging rays, 57a, 58a, 60a and the second of emerging rays, 61a, 62a, and 64a, as both sets have the same combination of wavelengths being transmitted through the glazing.

The following examples set forth suitable and/or preferred methods and results in accordance with the invention. It is to be understood, however, that these examples are provided by way of illustration and nothing therein should be taken as a limitation upon the overall scope of the invention. All percentages are by weight unless otherwise specified.

### Example 1. (Prophetic)

A laser projector is provided that emits light at wavelength ranges of 443 nm, 521 nm, and 643 nm, each of which ranges have a width less than about 2 nm, as defined by FWHM. The projector is oriented to emit light toward a glazing with a configuration that comprises, from the interior of the vehicle to the exterior, a first glass lite, a first PVB interlayer, a patterned HOE covering the entire surface area of the windshield, a second PVB interlayer with specially tailored absorptive properties that is the light-absorbing substrate, and a second glass lite. The second PVB interlayer with absorptive properties contains three dyes, Dye R, Dye G, and Dye B. The projector and HOE layer are adapted to provide an image to the glazing that is reflected toward a viewer from the HOE layer.

Dye R absorbs light centered at about 643 nm, and has a FWHM of about 30 nm, an absorptivity of about 90 L/g/cm, and is provided in the PVB interlayer in an amount of about 110 ppm.

Dye G absorbs light centered at about 521 nm, and has a FWHM of about 25 nm, an absorptivity of about 60 L/g/cm, and is provided in the PVB interlayer in an amount of about 180 ppm.

Dye B absorbs light centered at about 443 nm, and has a FWHM of about 28 nm, an absorptivity of about 160 L/g/cm, and is provided in the PVB interlayer in an amount of about 65 ppm.

When the projector projects light in the form of an image that is reflected toward the viewer, the main component of the image viewed by the driver is the result of a reflection off the HOE incorporated into the glazing. Furthermore, the light transmitted through the second piece of glass, from the exterior environment, is modified through the absorption of wavelengths centered around the absorption peaks of Dye R, G, and B. This absorption prevents these wavelengths from interacting with the HOE film, reducing or preventing the formation of external reflection (stray light) artifacts visible from outside the vehicle, as would be the case if the secondary PVB interlayer were not formulated with the R, G, B dyes.

### Example 2. (Prophetic)

A picture generation unit is provided that emits light across a broad spectrum of the visible wavelengths between 400 and 800 nm. The projector is oriented to emit light toward a glazing with a configuration that comprises, from the interior of the vehicle to the exterior, a first glass lite, a first PVB interlayer, a patterned HOE film that covers only a fraction of the surface area of the windshield, a second PVB interlayer with specially tailored absorptive properties, and a second glass lite. The patterned HOE film is designed to reflect light at wavelength ranges centered around 466 nm, 523 nm, and 623 nm, with a FWHM of approximately 7 nm. The second PVB with absorptive properties contains three dyes, Dye R, Dye G, and Dye B. The projector and HOE layer are adapted to provide an image to the glazing that is reflected toward a viewer from the HOE layer.

Dye R absorbs light centered at about 623 nm, and has a FWHM of about 26 nm, an absorptivity of about 210 L/g/cm, and is provided in the PVB interlayer in an amount of about 45 ppm.

Dye G absorbs light centered at about 523 nm, and has a FWHM of about 25 nm, an absorptivity of about 60 L/g/cm, and is provided in the PVB interlayer in an amount of about 180 ppm.

Dye B absorbs light centered at about 466 nm, and has a FWHM of about 25 nm, an absorptivity of about 145 L/g/cm, and is provided in the PVB interlayer in an amount of about 180 ppm.

When the projector projects light in the form of an image that is reflected toward the viewer, the main component of the image viewed by the driver is the result of a reflection off the HOE incorporated into the glazing. Furthermore, the light transmitted through the second piece of glass, from the exterior environment, is modified through the absorption of wavelengths centered around the absorption peaks of Dye R, G, and B. This absorption prevents or reduces these wavelengths from interacting with the HOE patterned part of the film, preventing or reducing the formation of external reflection artifacts visible from outside the vehicle, as would be the case for secondary PVB interlayer that were not formulated with the disclosed dyes.

The light absorption by the second PVB interlayer with R, G, B dyes also serves the purpose of maintaining the perceived color balance of incoming light transmitted through both the HOE patterned and unpatterned sections of the windshield. By absorbing the wavelengths of light from Dyes R, G, B uniformly across all parts of the windshield, the driver perceives a similarly balanced color spectrum both in areas with and without the HOE patterned photopolymer. Without such a specially formulated second PVB layer, the light transmitted through the areas of the windshield containing HOE patterned photopolymer would appear darker, and slightly color-shifted, relative to the areas of the windshield not containing HOE patterned photopolymer, due to the reflection of external light at the selected wavelength programmed into the HOE reflection film itself.

### Example 3. (Prophetic)

An LED projector is provided that emits light centered at wavelengths of 455 nm, 530 nm, and 625 nm, with ranges of 25 nm, 70 nm, and nm, respectively, as defined by FWHM. The projector is oriented to emit light toward a glazing with a configuration that comprises, from the interior of the vehicle to the exterior, a first glass lite, a first PVB interlayer, a photopolymer film that covers the majority or entirety of the surface area of the windshield but only a fraction of that area is HOE patterned, a second PVB interlayer with specially tailored absorptive properties, and a second glass lite. The patterned HOE film is designed to reflect light at wavelength ranges centered around 466 nm, 523 nm, and 623 nm, with a FWHM of approximately 7 nm. The second PVB with absorptive properties contains three dyes, Dye R, Dye G, and Dye B. The projector and HOE layer are adapted to provide an image to the glazing that is reflected toward a viewer from the HOE layer.

Dye R absorbs light centered at about 623 nm, and has a FWHM of about 26 nm, an absorptivity of about 210 L/g/cm, and is provided in the PVB interlayer in an amount of about 45 ppm.

Dye G absorbs light centered at about 523 nm, and has a FWHM of about 25 nm, an absorptivity of about 60 L/g/cm, and is provided in the PVB interlayer in an amount of about 180 ppm.

Dye B absorbs light centered at about 466 nm, and has a FWHM of about 25 nm, an absorptivity of about 145 L/g/cm, and is provided in the PVB interlayer in an amount of about 180 ppm.

When the projector projects light in the form of an image that is reflected toward the viewer, the main component of the image viewed by the driver is the result of a reflection off the HOE incorporated into the glazing. Furthermore, the light transmitted through the second piece of glass, from the exterior environment, is modified through the absorption of wavelengths centered around the absorption peaks of Dye R, G, and B. This absorption prevents or reduces these wavelengths from interacting with the HOE patterned part of the film, preventing or reducing the formation of external reflection artifacts visible from outside the vehicle, as would be the case for secondary PVB interlayer that were not formulated with the disclosed dyes.

The light absorption by the second PVB interlayer with R, G, B dyes also serves the purpose of maintaining the perceived color balance of incoming light transmitted through both the HOE patterned and unpatterned sections of the windshield. By absorbing the wavelengths of light from Dyes R, G, B uniformly across all parts of the windshield, the driver perceives a similarly balanced color spectrum in both the HOE patterned and unpatterned areas. Without such a specially formulated second PVB layer, the light transmitted through the unpatterned areas would have significantly less modification than the light transmitted through the HOE patterned areas, making the patterned areas appear darker, and slightly color-shifted, due to the reflection of external light at the selected wavelength programmed into the HOE reflection film itself.

### Example 4. (Prophetic)

A laser projector is provided that emits light at wavelength ranges of 466 nm, 523 nm, and 643 nm, each of which ranges have a width less than about 2 nm, as defined by FWHM. The projector comprises an HOE film intended to direct light onto the windshield. The windshield comprises two glass panes and a multilayer PVB interlayer design that contains three dyes, Dye R, Dye G, and Dye B. The projector is adapted to provide an image to the glazing that is reflected toward a viewer from the first air-glass interface.

Dye R absorbs light centered at about 643 nm, and has a FWHM of about 28 nm, an absorptivity of about 175 L/g/cm, and is provided in the PVB interlayer in an amount of about 55 ppm.

Dye G absorbs light centered at about 523 nm, and has a FWHM of about 25 nm, an absorptivity of about 60 L/g/cm, and is provided in the PVB interlayer in an amount of about 180 ppm.

Dye B absorbs light centered at about 466 nm, and has a FWHM of about 25 nm, an absorptivity of about 145 L/g/cm, and is provided in the PVB interlayer in an amount of about 180 ppm

When externally transmitted light passes through the light absorbing substrate, it is modified through the absorption of wavelengths centered around the absorption peaks of Dye R, G, and B. This absorption prevents or reducing these wavelengths from interacting with the HOE patterned film in the projector, preventing or reducing unwanted light redirection, off the HOE, back to the windshield or other location where it can be viewed by the driver as an optical artifact.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A display system for viewing information, comprising:
a. a glazing, comprising:
i. a first transparent rigid substrate;
ii. a second transparent rigid substrate; and
iii. a polymer interlayer, positioned between the first transparent substrate and the second transparent substrate,
wherein one face of the first transparent rigid substrate defines an inner surface of the glazing and one face of the second transparent rigid substrate defines an outer surface of the glazing;
b. one or more holographic optical elements which reflect light within three discrete wavelength ranges; and
c. one or more narrow-band absorbers that selectively absorb light within the three discrete wavelength ranges, disposed between the holographic-optical elements and the outer surface of the glazing.

2. The display system of claim 1, wherein the holographic optical elements are positioned in the polymer interlayer.

3. The display system of claim 1, wherein the holographic optical elements are positioned on the inner surface of the glazing.

4. The display system of claim 1, wherein the holographic optical elements are provided in or on a film positioned between the first rigid substrate and the polymer interlayer.

5. The display system of claim 1, further comprising a projector that emits light toward the first transparent rigid substrate of the glazing within the three discrete wavelength ranges.

6. The display system of claim 1, wherein the one or more holographic optical elements are positioned in the projector.

7. The display system of claim 1, wherein the one or more holographic optical elements are positioned between a light source in the projector and the inner surface of the glazing.

8. The display system of claim 1, wherein the one or more holographic optical elements are static.

9. The display system of claim 1, wherein the one or more holographic optical elements are created dynamically.

10. The display system of claim 1, wherein the projector is selected from a laser diode-based projector; an LED projector; a DPSS laser-based projector, a hybrid laser-LED projector, a laser projector, a light source combined with a spatial light modulator, or a light source combined with a waveguide.

11. The display system of claim 1, wherein the three discrete wavelength ranges include light of 445 nm, 515 nm, and 642 nm.

12. The display system of claim 1, wherein the three discrete wavelength ranges include light of 445 nm, 550 nm, and 642 nm.

13. The display system of claim 1, wherein the one or more narrow-band absorbers exhibit a FWHM from about to 50 nm.

14. The display system of claim 1, wherein the projector emits at least one wavelength range of light that exhibits a FWHM from about 0.5 nm to 100 nm.

15. The display system of claim 1, wherein the one or more holographic optical elements reflect light at a wavelength range that exhibits a FWHM from about 0.5 nm to 50 nm.

16. The display system of claim 1, wherein one wavelength range emitted by the projector includes light having a wavelength selected from one or more of 635, 638, 650, or 660.

17. The display system of claim 1, wherein at least one of the narrow-band absorbers is a polymethine dye.

18. The display system of claim 1, wherein the holographic optical elements comprise one or more diffraction gratings.

19. A method of preventing or reducing stray light artifacts resulting from reflection or transmission from one or more holographic optical elements, comprising placing one or more narrow-band absorbers between a light source and the one or more holographic elements that absorb the light that causes the stray light artifacts.

20. The method of claim 19, wherein the intensity of at least one stray light artifact is reduced by at least 50%.

21. The method of claim 19, wherein the narrow band absorbers and the one or more holographic optical elements are provided in a display system for viewing information, the display system comprising:
a. a glazing, comprising:
i. a first transparent rigid substrate;
ii. a second transparent rigid substrate; and
iii. a polymer interlayer, positioned between the first transparent substrate and the second transparent substrate,
wherein one face of the first transparent rigid substrate defines an inner surface of the glazing and one face of the second transparent rigid substrate defines an outer surface of the glazing;
b. the one or more holographic optical elements which reflect light within three discrete wavelength ranges; and
c. the one or more narrow-band absorbers that selectively absorb light within the three discrete wavelength ranges, the one or more narrow-band absorbers being disposed between the holographic-optical elements and the outer surface of the glazing.

22. The method of claim 21, wherein the holographic optical elements are positioned in the polymer interlayer.

23. The method of claim 21, wherein the holographic optical elements are positioned on the inner surface of the glazing.

24. The method of claim 21, wherein the holographic optical elements are provided in or on a film positioned between the first rigid substrate and the polymer interlayer.

25. The method of claim 21, wherein the display system further comprises a projector that emits light toward the first transparent rigid substrate of the glazing at the three discrete wavelength ranges.

26. The method of claim 21, wherein the one or more holographic optical elements are positioned in the projector.

27. The method of claim 21, wherein the one or more holographic optical elements are positioned between a light source in the projector and the inner surface of the glazing.

28. (canceled)

29. (canceled)

30. (canceled)

31. The method of claim 21, wherein the three or more discrete wavelength ranges include light of 445 nm, 515 nm, and 642 nm.

32. The method of claim 21, wherein the three or more discrete wavelength ranges include light of 445 nm, 550 nm, and 642 nm

33. The method of claim 21, wherein one of the discrete wavelength ranges emitted by the projector includes light having a wavelength selected from one or more of 635, 638, 650, or 660.

34. The method of claim 21, wherein the one or more narrow-band absorbers exhibit a FWHM from about to about 50 nm.

35. The method of claim 21, wherein the projector emits at least one wavelength range of light that exhibits a FWHM from about 0.5 nm to 100 nm.

36. The method of claim 21, wherein at least one of the one or more holographic optical elements reflects light at a wavelength range that exhibits a FWHM from about 0.5 nm to 50 nm.

37. The method of claim 21, wherein at least one of the narrow-band absorbers is a polymethine dye.

38. The method of claim 21, wherein the holographic optical elements comprise one or more diffraction gratings.
